(19) United States
(12) Patent Application Publication
(10) Pub. No.: US 2024/0174582 A1
(43) Pub. Date: May 30, 2024

(54) A NITROGEN GAS GENERATOR

(71) Applicant: EXXFIRE B.V., Noordwijk (NL)

(72) Inventors: Johannes Franciscus DEMMINK, Noordwijk (NL); René Johannes Wilhelmus DEN BOER, Noordwijk (NL); Cornelis Anthonius Hubertus SCHUURBIERS, Noordwijk (NL); Jeremy James FIELDING, Noordwijk (NL)

(73) Assignee: EXXFIRE B.V., Noordwijk (NL)

(21) Appl. No.: 18/284,633

(22) PCT Filed: Mar. 29, 2022
(86) PCT No.: PCT/EP2022/058336

§ 371 Date: Sep. 28, 2023

(30) Foreign Application Priority Data
Mar. 29, 2021 (NL) 2027858

(51) Int. Cl. C06B 35/00; A62C 5/00; C06B 23/04; C06B 45/04

(52) U.S. Cl. CPC C06B 35/00; A62C 5/006; C06B 23/04; C06B 45/04

(57) ABSTRACT

The invention is directed to a nitrogen gas generator comprising a housing having two ends, ignition means at one end of the housing and a gas outflow opening at the other end of the housing, a volume of a filter at the outflow opening, a volume of solid propellant comprising sodium azide, a binder, a coolant and between 1 and 10 wt % of iron (III) oxide. Between the ignition means and the volume of solid propellant an active layer is present. The active layer comprises between 60 and 90 wt % of sodium azide, between 1 and 15 wt % of a binder, between 0.1 and 10 wt % of a coolant and between 5 and 30 wt % of iron (III) oxide. The content of iron (III) oxide in the active layer is higher than the content of iron(III)oxide in the solid propellant.

The invention is directed to a nitrogen gas generator comprising a housing having two ends, ignition means at one end of the housing and a gas outflow opening at the other end of the housing, a volume of a filter at the outflow opening and a volume of solid propellant comprising of sodium azide, a binder, a coolant and between of iron (III) oxide as present between the ignition means and the volume of filter. Nitrogen gas is generated when the solid propellant combusts.

Such a gas generator is known from applicants WO2014/073970. This publication describes a nitrogen gas generator as present in a tubular housing. At one end ignition means are present which may be traditional pyrotechnical ignitors. Between these ignition means and a filter, which may be a sand filter, a composition consisting of sodium azide, potassium silicate, iron (III) oxide and lithium fluoride is present as the solid propellant or nitrogen generating composition. When ignited at one end of the nitrogen generating composition nitrogen gas is formed which flows via the not yet combusted nitrogen generating composition and the sand filter to an outflow opening. Via said outflow opening a relatively cool nitrogen gas is discharged into the environment. Such nitrogen gas generators are advantageously used to protect electrical devices such as computer servers against fire. This because the relatively cool nitrogen gas does not damage the electrical components of, for example, other equipment or servers in the vicinity of the fire.

U.S. Pat. No. 4,203,787 describes a solid propellant, also referred to as a nitrogen gas generating composition, based on sodium azide. According to this publication a successful initiation of the combustion of the sodium azide composition requires an adequate quantity of initiator to ensure that sufficient hot combustion products of the initiator contact enough of the exposed sodium azide composition to kindle a self sustaining flame front. A boron potassium nitrate-lead azide initiator is described in this publication.

U.S. Pat. No. 4,817,828 describes a nitrogen gas generator consisting of grains of 61 to 68 wt % sodium azide, 0 to 5 wt % sodium nitrate, 0 to 5 bentonite, 23 to 28 wt % iron oxide and 2 to 6 wt % of graphite fibers and 1 to 2 wt % of fumed silicon dioxide. The pyrotechnical igniter described consists of boron potassium nitrate and is preferred because it can minimize peak pressure and so avoid grain damage.

EP0619284 describes a nitrogen gas generator. The solid propellant consists of gamma iron oxide and sodium azide in an approximately stoichiometric ratio with respect to each other. More preferably about between 29 and 40 wt % gamma iron oxide and about between 71 and 60 wt % sodium azide is present In such a composition. The preferred ignitor may be a conventional igniter as described in U.S. Pat. No. 4,902,036. This igniter comprises a squib as present to ignite an enhancer packet comprising boron potassium nitrate as present in an enclosed space. Electric leads convey a current to the squib thereby igniting the squib and also the enhancer packet. The ignition of the rapidly combustible material provides the threshold energy required to ignite the nitrogen gas generating composition.

A problem with the prior art nitrogen gas generators is their reliability to perform. Nitrogen gas generators and especially nitrogen gas generators installed to extinguish fires preferably may not fail when ignited. In practice however it may occur that a very small percentage of the installed nitrogen generators fails to generate the optimum amount of nitrogen gas. The present invention is directed to a nitrogen gas generator which does not fail or at least always generates a minimum amount of nitrogen gas when ignited.

This is achieved by the following nitrogen gas generator. A nitrogen gas generator comprising
a housing having two ends, ignition means at one end of the housing and a gas outflow opening at the other end of the housing,
a volume of a filter at the outflow opening,
a volume of solid propellant comprising of between 70 and 90 wt % of sodium azide, between 1 and 15 wt % of a binder, between 0.1 and 20 wt % of a coolant and between 1 and 10 wt % of iron (III) oxide as present between the ignition means and the volume of filter, and
wherein between the ignition means and the volume of solid propellant an active layer is present and wherein the active layer comprises between 60 and 90 wt % of sodium azide, between 1 and 15 wt % of a binder, between 0.1 and 10 wt % of a coolant and between 5 and 30 wt % of iron (III) oxide, wherein the content of iron (III) oxide in the active layer is higher than the content of iron(III)oxide in the solid propellant.

Applicants now found that when an active layer comprising a relatively high iron oxide content is used a more reliable nitrogen gas generator is obtained. Further a quicker generation of nitrogen gas results. A next advantage is that further the sodium azide comprising active layer will also generate nitrogen gas and thus enhance the volume of nitrogen gas which can be generated by a single nitrogen gas generator according to this invention.

The invention is especially suited for a gas generator having igniter means which comprises a squib and enhancer packet. Suitably the wherein the enhancer packet comprises boron potassium nitrate, KBNO₃. It is found that when an active layer is present according to the present invention, propagation following the initiation is enhanced. This enhancement is demonstrated to improve reliability at same amounts of BKNO₃ and even enables reduction of the amount of BKNO₃. The nitrogen gas generator according to this invention can release its nitrogen quicker than a nitrogen generator not having an active layer and having a higher content of boron potassium nitrate. This feature is of relevance in applications requiring a fast response to a threat. Having to use less boron potassium nitrate is advantageous because it improves the safety when manufacturing and it improves the safety of the product. A further advantage is that using less boron potassium nitrate increases the purity of the released nitrogen gas.

A problem with the above system involving a squib and enhancer packet is that special safety measures have to be taken when assembling the nitrogen gas generator because of their explosive properties. A further disadvantage is that a special compartment within the nitrogen gas generator has to be present for the squib and enhancer packet. For this reason it may be preferred that the igniter means comprises of an electrically heated initiator, such as for example a glow plug. An electrically heated initiator is advantageous because no squib is required in combination with a boron potassium nitrate enhancer packet. Thus enabling a much simpler and safe assembly of the nitrogen gas generator. Furthermore no special compartment for the boron potassium nitrate comprising enhancer packet is required making the design simpler. An additional advantage of not having to use boron potassium nitrate is that no or significantly less nitric oxides are formed when the nitrogen gas generator is used. A further advantage is that the electrically heated initiator does not cause a surge of gas or shock waves within the nitrogen gas generator which may damage the gas generator. Such a surge of gas or shock waves may occur when the squib and enhancer packet is used as the ignitor means. A next advantage is that the electrically heated initiator and active layer combination provides a more reliable nitrogen gas generator is obtained for operation at lower ambient temperatures, such as minus 25° C.

The electrically heated initiator may be a glow plug such as known for use in a self-ignition, e.g. diesel engine. One glow plug would suffice for many applications. For high-reliability applications, such as aviation applications, it may be beneficial to have two glow plugs to achieve a dual, hence redundant, system. The glow plug typically is designed to be temporarily energized, preferably by electrical-resistance heating, to a preselected temperature in the range of from 200 to 1200° C. during a brief period. The glow plug preferably comprises a heating element assembly, including a—advantageously monolithic—sheath having a relatively thin and generally annular wall defining a blind bore, and a heating element positioned in the blind bore and adapted to emit heat, and preferably a heat transfer device adapted to transfer the heat from the heating element to the sheath.

The glow plug may have a conventional heating element, preferably at, or in proximity of its tip that includes a metal coil or metal filament enclosed in the heat-resistant metal or ceramic sheath.

The heating element preferably comprises at least one or more metal filament(s) or metal coil(s) preferably having a high electrical resistance, so that at least one of the one or more heats up rapidly when an electrical current is passed through it and thereby heats rapidly the sheath around it. The heating element preferably may further comprise an insulator to protect the heating element from direct contact with the sheath. This insulator may be formed from any suitable material, preferably a ceramic material.

The one or more heating filament(s) or coil(s) may preferably be protected from direct contact with the sheath by being encapsulated in the insulator, whereby the heating assembly comprising both heating filament or coil and insulator is encapsulated in the sheath.

The sheath may be formed from a preselected material which is chosen and configured so as to minimize failure of the heating element assembly caused by thermal stresses, oxidation and/or corrosion, and avoiding any stability or performance issues due to its proximity to the solid propellant. The sheath should in particular not contain any heavy metals, such as copper, lead, iron, nickel, silver and mercury, which could vaporize or otherwise migrate and thus form explosive and/or toxic heavy metal azides or other undesired compounds in the gas generator. This has the benefit that conventional metal coils or filaments comprising alloys of heavy metals may be employed, which otherwise would be unsuitable due to the risks involved in the direct contact with the propellant charge.

The metal coil or filament of the heating element of the glow plug is connected to a source of electricity. A preferred source of electricity can provide between 10 and 30 volts and provide between 5 and 20 Amperes (amps) to the glow plug for at least between 5-20 seconds, so that the sheath of the glow plug heats rapidly to a steady-state, operating temperature of at least 200° C., more preferably at least of at least 250° C.; more preferably at least 500° C., even more preferably at least 750° C. and preferably between 900 and 1200° C. and even more preferably between 900 and 1000° C. A particularly preferred source of electricity is a battery that can provide at least 12 volts and at least 10 amps to the glow plug for at least 10 seconds and that can be attached to the gas generator. The actual temperature that is at least to be achieved preferably is at, or above the self decomposition temperature of the active layer. The temperature should be sufficient to ignite the active layer.

When the metal coil of the heating element of the glow plug is electrified, the coil heats up due to its electrical resistance and causes its sheath to heat up until it glows. By applying only partial electrical power to the glow plug, the sheath of the glow plug can be heated to significantly less than its operating temperature and used, in this condition, to warm up the surrounding solid propellant of the generator, so that the propellant is ready to be initiated. When full electrical power is supplied to the coil of the heating element of the glow plug, its sheath will begin to glow and heat very significantly the surrounding solid propellant of the generator. When the portions of the active layer surrounding the glowing sheath of the glow plug reach a decomposition temperature, such portions of the active layer will begin to initiate, causing other portions of the active layer more remote from the sheath of the glow plug, to combust.

Preferably, portions of the active layer and particularly the sodium azide propellant of said layer may begin to initiate within 10 seconds, more preferably within 5 seconds, after the coil of the heating element of the glow plug has been supplied with full electrical power. The solid propellant layer itself may initiate within 20 to 90 seconds, more preferably within 30 to 60 seconds, after the coil of the heating element of the glow plug has been supplied with full electrical power.

Preferably the glow plug, once started, achieves the desired temperature in less than 5 seconds, more preferably in less than 3 seconds, more preferably in less than 2 seconds. The amount of electric power that must be supplied to a glow plug in accordance with this invention to initiate decomposition of the active layer will depend on the composition and physical appearance of said layer. Suitably at least 30 watts and preferably about 50 to 100 watts, of electricity should normally suffice to initiate a controlled, self-sustaining decomposition of an active layer.

The heating element of the glow plug is preferably positioned centrally within the gas generator's housing. The heating element of the glow plug is preferably encapsulated by the active layer. More specifically the sheath surrounding the one or more metal filament(s) or metal coil(s) having a high electrical resistance is at least partly encapsulated by the active layer. This allows the simple use of commercially obtainable glow plugs.

The solid propellant and the active layer may comprise the binder and coolant as known in the prior art and described in the earlier referred to applicant's WO2014/073970.

The binder as is comprised in the solid propellant and in the active layer may be the same or different and preferably the same. The binder may be a polytetrazole and preferably an alkaline non-organic binder material, more preferably an alkali metal silicate such as potassium silicate (K₂SiO₃). Preferably the binder is potassium silicate (K₂SiO₃) for the solid propellant and for the active layer.

The coolant as is comprised in the solid propellant and in the active layer may be the same or different. Preferred coolants are inorganic salts having a heat capacity of at least 1400 J/K/kg as determined at 600 K in order to provide sufficient cooling. The coolant also has an important function as slag modifier which helps keep the slag in place after the functioning of the gas generator. The heat capacity of the coolant is preferably at least 1900 J/K/kg. The coolant should be inert, so that it does not decompose or react with the other components in the generator at the reaction temperature of the gas generation. The coolant is preferably one or more compounds selected from LiF, Li₃N₃, Li₂SO₄, and Li₂Si0₃, or NaCl, NaF, KF, CaF₂, Li₂B₂O₄, Li₂B₄O₇. More preferred are the lithium compounds in view of their superior combined properties as slag modifier and most preferred is LiF.

The solid propellant comprises between 1 and 10 wt % of iron (III) oxide and preferably between 1 and 5 wt % of iron (III) oxide and even more preferably between 1 and 4 wt % of iron (III) oxide.

The solid propellant is suitably present as extrudates or more preferably as tablets. The extrudates or tablets are preferably of uniform size and shape. This ensures that a uniform packing with a well defined void space will be present of these extrudates or pellets. The presence of a void space is preferred because it provides a flow path for the nitrogen gas which is initially generated by the ignited active layer and subsequently by the solid propellant and which nitrogen gas flows towards the outflow opening at the other end of the housing via this void space as present between the non-reacted extrudates or tablets of solid propellant. Preferably extrudates or tablets of the solid propellant are present in the volume of solid propellant having a volume of between 25 and 1000 mm³ and more preferably between 50 and 500 mm³. The void space between the extrudates or tablets in the volume of solid propellant is suitably between 20 and 75% (vol/vol) and more preferably between 40 and 60% (vol/vol) of the total volume taken in by the solid propellant within the housing.

The preferred tablets are preferably bound together. This may be achieved by adding an interparticle binder, such as preferably an aqueous solution of K₂SiO₃ having a K₂SiO₃ content of between 10 and 30 wt. %, to the tablets of solid propellant when the tablets are placed within the housing of the nitrogen gas generator. Binding the tablets together is advantageous because it results in an improved packing which can maintain its structure, i.e. maintain the relevant voids, over time and avoids formation of packing defects such as short cuts and dead zones.

The active layer may be present as a layer of a homogenous powder, or as stacked particles, like extrudates or tablets. For example the active layer may be a cylindrical tablet having a diameter just allowing placement within a tubular housing.

Preferably the active layer is present as a layer of a homogeneous powder. Even more preferably such an active layer of a homogenous powder is preferably combined with a volume of solid propellant as present as tablets. A very preferred embodiment is where such an active layer of a homogenous powder is combined with a volume of solid propellant as present as tablets and wherein the ignition means comprises the glow plug. Even more preferably a channel is present through the active layer fluidly connecting the volume of solid propellant with the side of the active layer at which also the ignition means are present. Such a channel may suitably have a largest cross-sectional dimension, for example a diameter, of between 5 and 20 mm.

The active layer comprises between 60 and 90 wt % of sodium azide, between 1 and 15 wt % of a binder, between 0.1 and 10 wt % of a coolant and between 5 and 30 wt % of iron (III) oxide.

The volume ratio of the volume of the active layer and the volume of solid propellant is between 5:95 and 30:70 (vol/vol). The volumes are the volumes of the spaces within the housing occupied by the total of active layer and the total solid propellant including any void space and not the spaces occupied by the individual tablets.

The filter may be any inter material which allows passage of the nitrogen gas and which has a heat capacity to lower the temperature of the nitrogen gas. Suitable filters are described in the earlier cited WO2014/073970 and may be activated carbon, sand, a zeolite or a metal. The volume ratio of the volume of a filter and the volume of solid propellant is between 20:80 and 60:40 (vol/vol) and more preferably between 30:70 and 60:40 (vol/vol).

The housing may have any shape. Preferably the housing is an elongated housing such to enable a combustion front of solid propellant which moves from one end to the end comprising the outflow opening. The cross-section may have any shape. Preferred shapes are tubular shapes because they provide the optimal strength per mass of the housing.

The invention shall be illustrated by the following non-limiting examples.

### EXAMPLE 1

A tube a housing having two ends, ignition means at one end of the housing and a gas outflow opening at the other end of the housing is filled with a layer of solid propellant LE tablets having a composition as stated in Table 1. The solid propellant LE tablets had a volume of 117 mm³/tablet. The void space in this layer was about 49% (vol/vol). The length of the layer was 168 mm.

Between the layer of solid propellant and the gas outflow opening a layer of 90 mm of sand was present. At its opposite side an active layer of 12 mm is present of a TL powder having a composition as in Table 1. In this layer a small axial channel having a diameter of about 12 mm was present connecting ignitor and the layer of solid propellant LE tablets. In the active layer a squib and enhancer packet containing KBNO₃ grains was present as the ignitor.

TABLE 1

| Component | HE tablets | LE tablets | TL powder |
|---|---|---|---|
| Tablet volume | 117 | 117 | No tablets |
| (mm³/tablet) | | | |
| NaN₃ (wt %) | 80.8 | 80.7 | 77.8 |
| LiF (wt %) | 12.7 | 14.0 | 8.7 |
| Fe₂O₃ (wt %) | 3.0 | 1.8 | 10 |
| K₂SiO₃ (wt %) | 3.5 | 3.5 | 3.5 |

The above described tube was kept at ambient temperatures for several hours before igniting the active layer and the pressure, temperature and time for the nitrogen to discharge from the gas generator was measured. The time at which the highest pressure at the gas outflow opening was measured. The time was measured at which 75 wt % (T75) and 95 wt % (T95) of the theoretically possible amount of nitrogen gas was discharged. The results are presented in Table 2.

### EXAMPLE 2

Example 1 was repeated except that HE tablets were used instead of the LE tablets. The results are presented in Table 2.

### EXAMPLE 3

Example 2 was repeated except that no axial channel was present in the layer of TL powder. The results are presented in Table 2.

### Comparative Experiment A

Example 2 was repeated except that no active layer of a TL powder was present. The squib and enhancer packet containing KBNO₃ grains was present as the ignitor directly contacting the solid propellant HE tablets. The results are presented in Table 2.

TABLE 2

| | Time at | | |
|---|---|---|---|
| | maximum | | |
| Example | pressure (s) | T75 (s) | T95 (s) |
| 1 | 35 | 36.8 | 45 |
| 2 | 15 | 14.6 | 17.3 |
| 3 | 23 | 24.2 | 40.2 |
| A | 46 | 44.2 | 52.4 |

The results in Table 2 show that when an active layer is present more nitrogen gas is generated and discharged within a shorter time as compared to when no such active layer is present.

### EXAMPLE 4

Example 2 was repeated three times at ambient conditions and the results are provided in Table 3 (Ex. 4a, 4b, 4c). In this table also the conversion is presented as wt %. The conversion is the percentage of nitrogen produced as compared to the theoretical maximum possible nitrogen which could be produced based on the available NaN₃ in the HE tablets and TL powder.

### Comparative Experiment B

Comparative experiment A was repeated three times. In all experiments the propagation failed resulting in very low conversions. The results are in Table 3 as B1, B2, B3 and B4.

TABLE 3

| | TL | T75 (s) | T95 (s) | Conversion |
|---|---|---|---|---|
| 4a | Yes | 5.4 | 7.6 | 99.6% |
| 4b | Yes | 21.8 | 30.6 | 97.3% |
| 4c | Yes | 16.6 | 20.9 | 99.3% |
| B1 | No | Propagation | Propagation | 2.4% |
| | | failed | failed | |
| B2 | No | Propagation | Propagation | 1.4% |
| | | failed | failed | |
| B3 | No | Propagation | Propagation | 1.9% |
| | | failed | failed | |
| B4 | No | 31.1 | 40.9 | >99.9% |

The results in Table 3 show that the repeatability and reliability of the nitrogen gas generators provided with an active layer is better when compared to the results obtained with the nitrogen gas generator which does not have such an active layer.

### EXAMPLE 5

Example 1 was repeated except that tube was kept at minus 25° C. (−25° C.) for several hours before igniting the active layer. The results are provided in Table 4.

### Comparative Experiment C

Comparative experiment A was repeated except that tube was kept at minus 25° C. (−25° C.) for several hours before igniting. The results are provided in Table 4.

### EXAMPLE 6

Example 1 was repeated except that tube was kept at 65° C. (+65° C.) for several hours before igniting the active layer. The results are provided in Table 4.

### Comparative Experiment D

Comparative experiment A was repeated except that tube was kept at 65° C. (+65° C.) for several hours before igniting. The results are provided in Table 4.

TABLE 4

| | TL | T(° C.) | T75 (s) | T95 (s) | Conversion |
|---|---|---|---|---|---|
| 5 | Yes | −25 | 8.8 | 13.5 | 99.6% |
| C | No | −25 | 65.4 | 84.5 | 99.4% |
| 6 | Yes | +65 | 3.1 | 5.1 | >99.9% |
| D | No | +65 | 32.8 | 35.0 | 98.5% |

Comparing the results of Example 5 and Experiment C and Example 6 with Experiment D shows that at the extreme low temperatures and at the high temperatures the presences of an active layer results in a much quicker generation of the nitrogen gas as shown by the lower T75 and T95.

All the generators of Examples 4-6 and Experiments B-D were allowed to cool down to be opened at controlled conditions. It was observed that the gas generators having the active layer showed a better conversion in radial direction which is believed to contribute to the desired more reliable propagation in the axial direction.

### Comparative Experiment E

A small scale cool gas generators with 58 gram N₂ production capacity comprised of HE tablets (Table 1) and porosity similar to previous examples was initiated using a standard glow plug. The decomposition reaction was initiated 20 seconds after activating the glow plug and full decomposition was reached 10 seconds after initiation (or 30 seconds after activation of glow plug)

### Comparative Experiment F

A second small scale cool gas generators similar to the device used in Experiment E was initiated using a fast high T glow plug. The decomposition reaction was now initiated 7 seconds after activating the glow plug and full decomposition was again reached 10 seconds after initiation (or 17 seconds after activation of glow plug)

### EXAMPLE 7

In a small scale generator similar to the device used in Experiment F, 10 wt % of the HE tablet grain was replaced by a high energy Top Layer comprised of TL powder (Table 1). The decomposition reaction was now initiated 3 seconds after activating the glow plug and full decomposition was reached 4 seconds after initiation (or 7 seconds after activation of the glow plug). Example 7 shows that the presence of an active layer results in more than twice as fast initiation and full decomposition compared to a gas generator initiated by a glow plug and not having such an active layer.

1. A nitrogen gas generator comprising:
a housing having two ends, ignition means at one end of the housing and a gas outflow opening at the other end of the housing,
a volume of a filter at the outflow opening,
a volume of solid propellant comprising of between 70 and 90 wt % of sodium azide, between 1 and 15 wt % of a binder, between 0.1 and 20 wt % of a coolant and between 1 and 10 wt % of iron (III) oxide as present between the ignition means and the volume of filter, and
wherein between the ignition means and the volume of solid propellant an active layer is present and wherein the active layer comprises between 60 and 90 wt % of sodium azide, between 1 and 15 wt % of a binder, between 0.1 and 10 wt % of a coolant and between 5 and 30 wt % of iron (III) oxide, wherein the content of iron (III) oxide in the active layer is higher than the content of iron(III)oxide in the solid propellant.

2. The gas generator according to claim 1, wherein the solid propellant comprises between 1 and 4 wt % of iron (III) oxide.

3. The gas generator according to claim 1, wherein the content of iron (III) oxide in the active layer is at least two times the content of iron (III) oxide in the solid propellant.

4. The gas generator according to claim 3, wherein the content of iron (III) oxide in the active layer is at least three times the content of iron (III) oxide in the solid propellant.

5. The gas generator according to claim 1, wherein the igniter means comprises a i) squib and enhancer packet or ii) a glow plug.

6. The gas generator according to claim 5, wherein the enhancer packet comprises KBNO₃.

7. (canceled)

8. The gas generator according to claim 5, wherein the glow plug has a heating element which is encapsulated by the active layer.

9. The gas generator according to claim 1, wherein the binder in the solid propellant and/or the active layer is comprised of a non-organic binder material.

10. The gas generator according to claim 9, wherein the binder in the solid propellant and/or the active layer is comprised of a alkaline non-organic binder material.

11. The gas generator according to claim 10, wherein the binder is potassium silicate (K₂SiO₃).

12. The gas generator according to claim 1, wherein the coolant is LiF.

13. The gas generator according to claim 1, wherein the solid propellant is present as tablets having a volume of between 50 and 500 mm³.

14. The gas generator according to claim 13, wherein the tablets are bound together.

15. The gas generator according to claim 13, wherein the void space between the tablets in the volume of solid propellant is between 40 and 60% (vol/vol) of the total volume taken in by the solid propellant within the housing.

16. The gas generator according to claim 13, wherein the active layer is a layer of a homogeneous powder and the ignition means comprises a glow plug.

17. The gas generator according to claim 15, wherein the volume ratio of the volume of the active layer and the volume of solid propellant is between 5:95 and 30:70 (vol/vol).

18. The gas generator according to claim 1, wherein the volume ratio of the volume of a filter and the volume of solid propellant is between 30:70 and 60:40 (vol/vol).

19. The gas generator according to claim 1, wherein the housing is a tubular housing.

20. The gas generator according to claim 1, wherein a channel is present through the active layer fluidly connecting the volume of solid propellant with the side of the active layer at which the ignition means are present.

21. The gas generator according to claim 20, wherein the channel has a largest cross-sectional dimension of between 5 and 20 mm.
